(19) United States
(12) Patent Application Publication
(10) Pub. No.: US 2022/0075344 A1
(43) Pub. Date: Mar. 10, 2022

(54) A METHOD OF FINDING A TARGET ENVIRONMENT SUITABLE FOR GROWTH OF A PLANT VARIETY

(71) Applicant: Yield Systems Oy, Helsinki (FI)

(72) Inventors: Jussi GILLBERG, Helsinki (FI); Paul WAGNER, Helsinki (FI); Linh NGUYEN, Helsinki (FI); Harri JUNTUNEN, Helsinki (FI); Jarno LINTUSAARI, Helsinki (FI)

(73) Assignee: Yield Systems Oy, Helsinki (FI)

(21) Appl. No.: 17/415,680

(22) PCT Filed: Dec. 18, 2019
(86) PCT No.: PCT/FI2019/050905

§ 371 Date: Jun. 17, 2021

(30) Foreign Application Priority Data
Dec. 21, 2018 (FI) 20186133

(51) Int. Cl. G05B 19/406; G06N 20/00

(52) U.S. Cl. CPC G05B 19/406; G05B 2219/37591; G06N 20/00

(57) ABSTRACT

A method for obtaining new plant growth data according to an experimentation objective, the method including defining an experimentation objective; defining a set of experimentation alternatives; obtaining a data set of experimentation alternative conditions; obtaining a trained plant growth model including plant growth model parameters; defining an experimental design utility function based on the experimentation objective; selecting an experimentation plan from the set of experimentation alternatives by using the trained plant growth model, the experimental design utility function, and the data set of experimentation alternative conditions; and performing the selected experimentation plan to obtain new plant growth data.

### TECHNICAL FIELD

The present disclosure relates generally to plant testing and more specifically to a method for obtaining new plant growth data according to an experimentation objective. In one aspect, the present disclosure also relates to a method of finding a target environment suitable for growth of a plant variety. Furthermore, the present disclosure also relates to a method for selecting a plant variety for a target environment.

### BACKGROUND

With advancement in technologies, there has been rapid development in field of agronomic practices. Furthermore, agriculture has always been an important part of a country's economy. Moreover, need for agricultural products is growing with the increasing population. Therefore, there is a need to increase quality and quantity of agricultural products. One technique that has been well regarded is plant testing. Plant testing is used for the purposes of plant breeding (where variety candidates are tested) and for plant variety testing performed by the officials to determine the value of new plant varieties. Plant testing requires obtaining plant growth data according to an experimentation objective. More specific cases of plant testing include determination of a suitable environment for growth of a plant variety and determination of a suitable plant variety for a target environment.

Traditionally, determination of the suitable environment for a plant variety involves growing and monitoring the growth of the plant variety of interest in such environment, where the new plant variety is expected to perform well. For example, plant seeds may be developed for growing in Southern Germany. In such a case, the developed plant seeds need to be tested in a field environment in Southern Germany. Therefore, the aforesaid technique is time consuming, since the plants can be tested in Southern Germany only during the natural growing season.

To overcome such limitations some modern techniques have been developed. These modern techniques employ maintaining controlled environmental conditions within an area, with the help of machines and other electronic equipment to monitor the growth of plant in the controlled environment. However, these modern techniques also have certain limitations associated therewith. It is for example difficult to decide what kind of environmental parameters to simulate. Due to this, testing is often performed under simplistic conditions that produce results that do not generalize to field conditions. Plants are often tested only under certain specific environmental conditions and the results of testing may be difficult to generalize to field conditions, where environmental conditions vary on every field. Furthermore, cost is prohibitively high for large-scale use. The high cost is driven by the high degree of homogeneity that is imposed within the environment; e.g. ensuring that the temperature within the apparatus remains within 0.2° C. will cost substantially more than allowing a variation of ±0.8° C.

Therefore, in light of the foregoing discussion, there exists a need to overcome the aforementioned drawbacks associated with plant testing. Speed, reliability and flexibility of methods for obtaining new plant growth data according to an experimentation objective can be improved.

### SUMMARY

The present disclosure seeks to provide a method for obtaining new plant growth data according to an experimentation objective. The present disclosure seeks to provide a method of finding a target environment suitable for growth of a plant variety. The present disclosure also seeks to provide a method for selecting a plant variety for a target environment. The present disclosure seeks to provide a solution to the existing problem of determination of suitable environment for plant growth. This disclosure redesigns plant testing to capitalize on the possibilities of plant growth modelling or more generally machine learning. An aim of the present disclosure is to provide a solution that overcomes at least partially the problems encountered in prior art, and provides an optimal method for finding target environment suitable for growth of a plant variety.

In one aspect, an embodiment of the present disclosure provides a method for obtaining new plant growth data according to an experimentation objective, the method comprising
obtaining a trained plant growth model comprising plant growth model parameters;
defining an experimentation objective, wherein the experimentation objective comprises reducing uncertainty about a plant growth model parameters;
defining a set of experimentation alternatives;
obtaining a data set of experimentation alternative conditions;
defining an experimental design utility function based on the experimentation objective;
selecting an experimentation plan from the set of experimentation alternatives by using the trained plant growth model, the experimental design utility function, and the data set of experimentation alternative conditions; and
performing the selected experimentation plan to obtain new plant growth data.

In another aspect, an embodiment of the present disclosure provides a method of finding a target environment suitable for growth of a plant variety, the method comprising
defining a test area;
defining at least one environmental recipe comprising values of a first set of environmental parameters;
planting a plurality of plants to grow within the test area;
adjusting environmental conditions for the test area according to the at least one environmental recipe;
defining a plurality of spatial sub-areas within the test area, wherein within each sub-area the values of the first set of environmental parameters are within a predefined range;
measuring the values of a first set of environmental parameters for a plurality of points in the test area to estimate the values of the first set of environmental parameters in the plurality of sub-areas;
monitoring growth of the plants in the plurality of sub-areas; and
selecting target environmental parameter values comprising values of a second set of environmental parameters based on the monitored growth of the plants.

In yet another aspect, an embodiment of the present disclosure provides a method for selecting a plant variety for a target environment, the method comprising
defining a target environment;
creating at least one environmental recipe comprising values of a first set of environmental parameters based on the target environment;
planting a plurality of plants to grow within a test area;
implementing the at least one environmental recipe in the test area;
defining a plurality of spatial sub-areas within the test area, wherein within each sub-area the values of the first set of environmental parameters are within a predefined range;
measuring environmental parameters for a plurality of points in the test area to estimate the values of the first set of environmental parameters in the sub-areas;
monitoring growth of the plants in the plurality of the sub-areas; and
selecting at least one plant based on the monitored growth of the plants.

In yet another aspect, an embodiment of the present disclosure provides a system for creating new plant growth data comprising
a test area for growing a plurality of plants, wherein the test area comprises a plurality of spatial sub-areas, wherein the plurality of spatial sub-areas are under conditions of a first set of environmental parameters,
environmental manipulators, the environmental manipulators configured to adjust environmental conditions within the test area according to one or more environmental recipes;
a first sensory arrangement configured to measure values of the first set of environmental parameters for a plurality of points in the test area to estimate the values of the first set of environmental parameters in the sub-areas;
a second sensory arrangement configured to monitor growth of the plants in the plurality of sub-areas, wherein the second sensory arrangement comprises at least one of a growth sensor or a camera and
a server arrangement for storing a new plant growth data, the new plant growth data comprising the measured values of the first set of environmental parameters and monitored growth.

Embodiments of the present disclosure substantially eliminate or at least partially address the aforementioned problems in the prior art, and enables reliable, efficient and cost-effective aforesaid methods.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a block diagram of architecture of a system for finding a target environment suitable for growth of a plant variety, in accordance with an embodiment of the present disclosure;

FIG. 2 is an exemplary representation of environmental conditions generated within a test area, in accordance with an embodiment of the present disclosure;

FIG. 3 illustrates steps of a method for obtaining new plant growth data in accordance with an embodiment of the present disclosure;

FIG. 4 illustrates steps of a method of finding a target environment suitable for growth of a plant variety in accordance with an embodiment of the present disclosure;

FIG. 5 illustrates steps of a method for selecting a plant variety for a target environment in accordance with an embodiment of the present disclosure; and

FIG. 6A and FIG. 6B are an exemplary set up according with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In one aspect, an embodiment of the present disclosure provides a method of obtaining new plant growth data according to an experimentation objective. The method comprising
obtaining a trained plant growth model comprising plant growth model parameters;
defining an experimentation objective, wherein the experimentation objective comprises reducing uncertainty about a plant growth model parameters;
defining a set of experimentation alternatives;
obtaining a data set of experimentation alternative conditions;
defining an experimental design utility function based on the experimentation objective;
selecting an experimentation plan from the set of experimentation alternatives by using the trained plant growth model, the experimental design utility function, and the data set of experimentation alternative conditions; and
performing the selected experimentation plan to obtain new plant growth data.

In another aspect, an embodiment of the present disclosure provides a method of finding a target environment suitable for growth of a plant variety. The method comprising
defining a test area;
defining at least one environmental recipe comprising values of a first set of environmental parameters;
planting a plurality of plants to grow within the test area;
adjusting environmental conditions for the test area according to the at least one environmental recipe;
defining a plurality of spatial sub-areas within the test area, wherein within each sub-area the values of the first set of environmental parameters are within a predefined range;
measuring the values of a first set of environmental parameters for a plurality of points in the test area to estimate the values of the first set of environmental parameters in the plurality of sub-areas;
monitoring growth of the plants in the plurality of sub-areas; and
selecting target environmental parameter values comprising values of a second set of environmental parameters based on the monitored growth of the plants

In another aspect, an embodiment of the present disclosure provides a method for selecting a plant variety for a target environment. The method comprising
defining the target environment;
creating at least one environmental recipe comprising values of a first set of environmental parameters based on the target environment;
planting a plurality of plants to grow within a test area;
implementing the at least one environmental recipe in the test area;
defining a plurality of spatial sub-areas within the test area, wherein within each sub-area the values of the first set of environmental parameters are within a predefined range;
measuring environmental parameters for a plurality of points in the test area to estimate the values of the first set of environmental parameters in the sub-areas;
monitoring growth of the plants in the plurality of the sub-areas;
and
selecting at least one plant based on the monitored growth of the plants.

In yet another aspect, an embodiment of the present disclosure provides a method for estimating parameter values for a plant growth model, the method comprising:
defining the plant growth model;
defining a target environment;
extracting environmental parameters for the target environment;
defining sub-areas within the targeted environment;
measuring growth of a plant in a plurality of the sub-areas; and
adjust the parameters of the plant growth model based on the measured growth.

The aforesaid methods substantially maintain heterogeneity of environmental parameters within the test area, thereby enabling the one or more plant varieties to be exposed to gradients of the environmental parameters. As a result, there is substantial reduction in number of environment manipulators employed to adjust the environmental parameters in the employed set-up for executing the present method as compared to conventional testing set-ups, thereby reducing the cost thereof. Furthermore, the heterogeneity of the environmental parameters within the environment enables observing growth traits under a range of environmental conditions which enables finding suitable environmental parameters for the growth of the plant variety. Notably, the aforesaid method yields cost efficient data that enables optimising growing conditions. Beneficially, the aforesaid method is substantially less time consuming, more reliable and more efficient. The present disclosure provides an efficient method for generating plant growth data.

The present method proposes to relax the constraint of maximal homogeneity, as adopted in conventional techniques for estimating the performance of a plant by using controlled environments. To benefit from the resulting heterogeneity, the environmental parameter values within the test area are estimated very accurately on a sub-area-specific scale, and machine learning or plant growth models are used to statistically estimate the performance of different plants under varying conditions from the results obtained (for example estimates of phenotype traits such as yield, plant height, etc. for the sub-areas and the sub-area specific environmental parameter values). Plants can then be compared in terms of their performance under a range of conditions rather than in terms of their performance under some specific environmental conditions. Optionally, the data is used to estimate plant growth model parameters using the data obtained and comparison is performed by comparing estimated performance in the test area. Image processing, when used, enables estimating plant individual-specific traits (such as yield, grain size and seed count etc.).

Throughout the present disclosure, the term “set” refers to one or more. In an example, a set of conditions from a group comprising conditions A, B, C may contain for example only condition B, only conditions A and C or conditions A, B and C as well as further conditions. In general, “obtaining” means retrieving the relevant information, data, model etc. from a database or similar, either from an own database or from a third party database.

Throughout the present disclosure, the term “plant variety” used herein relates to plants with a particular genotype (for example, from the plant species of barley, wheat, maize) or combination of genotypes (for population varieties, such as are used for rye). Throughout the present disclosure, the term plant variety refers to both variety candidates in a plant breeding program as well as varieties which have already been granted the legal variety status. Phenotypic characteristics often distinguish one plant variety from other varieties. For example, different wheat varieties may exhibit different characteristics like grain size, colour, chemical composition and the like. In consideration of whether or not two plants have the same genotype or not, also other information than genotype measurements can be used. For example, a low-resolution single nucleotide polymorphism (SNP) measurement may imply that the genotypes of two plants are the same, however, a plant breeder may know that the plants will not have the same genotype due to them being created in a different crossing event.

Throughout the present disclosure, a plurality of plants can comprise one or more plant varieties. Furthermore, the plant varieties may be of one or more species. For example, when selecting a plant suitable for a target environment, the varieties studied in the test area may comprise barley and wheat varieties.

Throughout the present disclosure, the term “target environment” used herein relates to an environment (namely, environmental conditions) suitable for growing the plant variety. The target environment may be defined in terms of geography. The target environment may be defined as the growing conditions of a greenhouse. The growing conditions of the target environment may be further defined as ranges or probability distributions of environmental conditions.

Throughout the present disclosure, the term “target environment data” refers to environmental data describing the environmental conditions in the target environment comprising values of the second set of environmental parameters. In an example, target environment data comprises time series of soil measurements, time series of weather data and time series of satellite images from the target environment that is defined as the geographic location “Southern France”. The target environment data may comprise ranges of the values of the second set of environmental parameters. The target environment data may comprise probability distributions of the values of the second set of environmental parameters.

The properties of the target environment are described as the values of a second set of environmental parameters. The second set of environmental parameters may comprise any environmental parameters. The target environment may comprise geographic location parameters (such as altitude, latitude), climatic parameters (such as daily temperature and precipitation values, ranges and probability distributions of temperature and precipitation), soil and other growing medium properties (such as chemical and physical decomposition). The target environment may be defined as a geographic location corresponding to a location parameter value that further implies values of physical and chemical properties of the growing medium such as soil (represented as environmental parameter values). The location parameter value may further imply environmental parameter values related to weather and probability distributions of the environmental parameters related to weather. In an example, the target environment corresponds to geographic region. In the target environment data, the target environment is described in terms of location parameters which further relate to the microclimate specified by the location parameters and the target environment data comprise values of the environmental parameters related to weather in the particular microclimate specified by the location parameter. In an example, the target environment may include a small or limited geographic region exhibiting a specific microclimate corresponding to a joint probability distribution of environmental parameters such as temperature, precipitation, radiation and soil properties. In another example, the target environment may be a large geographic area such as Southern France. In still another example, the target environment for growth of the plant variety may be an environment with high rainfall after the typical time for sowing in that environment. In yet another example, the target environment for growth of the plant variety may include a hot environment with less rainfall during all growth stages. In yet another example, the target environment for growth of the plant variety may include a hot and humid environment. As an example, the target environment for growing a wheat variety may include well drained fertile loams of alluvial or black soil, warm temperature within a range of 21-24° C. and 31 to 38 cm of average rainfall before flowering. In another example, the target environment may consist of greenhouse conditions where plants are grown hydroponically, the length of the daily photoperiod is 20 hours and the spectrum emitted by the light source has a peak around the wavelength of 600 nm. Throughout this disclosure, the term “target environmental parameters” refers to the second set of environmental parameters.

In this description, there are several sets of environmental parameters. Typically, a first set of environmental parameters is the set for environmental parameters that are measured to describe environmental conditions in the test area while a second set of environmental parameters is those parameters that are measured to describe environmental conditions in the target environment. The third set of environmental parameters is the set of environmental parameters that are measured in field trials and the fourth set of environmental parameters is the set of environmental parameters whose values are given as input to a plant growth model. The parameters themselves can be same or different from one set to another, such as each set may comprise temperature or only one set may comprise temperature. In an example, the first set of parameters consists of daily air temperature and daily soil moisture measured 20 cm below the surface, the second set of environmental parameters consists of daily temperature and daily infrared spectrum values from satellite images of the target area, the third set of environmental parameters consists of daily precipitation and daily temperature and the fourth set of environmental parameters consists of temperature and daily soil moisture measured 10 cm below the surface. In this example, the environmental conditions measured as environmental parameter values are different for the test area, the target environment and field trial data. Furthermore, in the present example, the environmental parameters used as input for the plant growth model are further different from the previous sets of environmental parameters. In this example, the values of the environmental parameters in one set may be estimated based on the values of the environmental parameters in another set. In the current example, soil moisture at 20 cm depth (in first set of environmental parameters) may be estimated by using satellite images (infrared spectrum, in the second set of environmental parameters) and the daily precipitation (third set of environmental parameters) and daily soil moisture 10 cm below the surface (fourth set of environmental parameters). Thus, while different data sources are available for the test area, the target environment, field trials and the plant growth model may further take as input other environmental parameters, the plant growth model can process information from the different data sources and output predictions of phenotype traits with the different data sources.

Throughout the present disclosure, the term “suitable” implies that growing the selected plant variety in the target environment has a high probability (such as above 70 or 80%) of reaching desired values of a selected performance score. Throughout the present disclosure, the term “performance score” refers to phenotype traits such as yield, protein content and starch content. Optionally, the term performance score refers to economical outcomes of agriculture such as revenues achieved by growing the plant variety and selling the agronomic output. The performance score can be defined as a mathematical function that takes as input phenotype traits, optional statistics such as sales price and optional other data needed to evaluate the mathematical function. In an example, expected yield is used as the performance score and a plant variety is considered suitable for being grown in Southern Australia when the expected yield is more than 4000 kg/HA.

Optionally, the term “suitable” implies that the plant variety performs well in terms of the performance score as compared with agronomic alternatives. For example, a wheat variety that provides a higher expected yield than other wheat varieties when used in the target environment in considered suitable for the target environment. As another example, the revenues of growing the plant variety of wheat in that environment provides better revenues than what is achieved by growing varieties of other plants such as oats or barley. As another example of a performance score defined in terms of comparison with agronomic alternatives, the plant variety that requires less fertilization than 50% of other plant varieties grown in the target environment in the recent years in order to reach a certain level of expected yield in the target environment is considered suitable. As another example of a performance score, the grains of the plant variety have a protein content higher than 70% of the plant varieties grown in the target environment in the recent years. Optionally, the performance score is defined as a mathematical function of phenotype traits and economic and other agronomic outcomes and environmental parameters. In an example, the performance score is defined as expected yield of a plant variety in the target environment when the summed total precipitation during the growing season is less than 100 mm. Optionally, performance scores are defined in relation to environmental conditions. In an example, the performance score is the expected yield for a very dry growing season, where the very dry growing season is specified in terms of the values of the second set of environmental parameters such as rainfall during germination of less than 5 mm. Optionally, performance scores refer to taste and texture properties when the plants are used for manufacturing food. In an example, the performance score consists of the time that a plant variety remains in a certain developmental state (measured for example in time or effective temperature sum).

The method comprises specifying an experimentation objective. Throughout this disclosure, an “experimentation objective” is an objective for which new plant growth data is obtained for and the experimentation objective is defined in terms of statistics of selected metrics. In other words, the experiment is performed in order to create new information needed to advance the experimentation objective and advancement is measured as statistics of associated metrics. In an example, the experimentation objective is to estimate the agronomic performance of a plant variety in a target environment, the agronomic performance being defined in terms of the statistics of a selected performance score such as for example the expected yield (a statistic that takes into account uncertainty related to yield) in the target environment. In another example, the experimentation objective is to estimate the impact of specified environmental conditions, encoded as an environmental recipe, on selected performance scores of a plurality of plant varieties.

In an example, the experimentation objective is to identify lighting conditions, encoded as environmental parameter values, under which the plants proceed from one growth stage to the next as slowly as possible.

In yet another example, the experimentation objective is to reduce uncertainty about the plant growth model parameters maximally. In such an example, the objective is to create such an experimentation plan that the expected outcome of the implemented experimentation plan provides maximal information gain about plant growth model parameters. The “experimentation plan” comprises a selection of one or more plant varieties to be included in an experiment (referred to as experiment plant variety selections), selection of the environmental conditions under which the experiment plant variety selections are grown (referred to as experiment environment selections). Optionally, the experimentation plan comprises a selection of a performance score to be estimated in the experiment (referred to as experiment performance score selection). The selection of a performance score results in selecting phenotype traits to measure, such phenotype traits being measured that are used for evaluating the selected performance score. The performance scores are then estimated based on the phenotype trait measurements.

The experiment plant selections, the experiment environment selections and the optional experiment performance score selections are selected from the set of experimentation alternatives. Throughout this closure, the “set of experimentation alternatives” comprises the set of possible experiment plant variety selections (which plant varieties can be selected to be included in the experiments), the set of possible experiment performance score selections (which performance scores can be selected to be studied by measuring phenotype traits in the experiments) and the set of possible experiment environment selections (which environmental conditions can be selected for performing the experiments). In an example, the set of possible experiment environment selections comprises fields in ten different locations and the experiment environment selections comprise selecting one or more of these locations, where to conduct field trials. In another example, the set of possible experiment environments comprises performing an experiment in a test area with any environmental parameter values that can be implemented as the environmental conditions in the test area. In such a case, the experiment environment selections are made by selecting the values of the environmental parameters to be implemented in the experiment. In another example, the set of possible experiment performance score selections comprise the set of performance scores, that can be estimated when performing experiments to obtain new plant growth data. In a further example, the experiment environment selections comprise of fields A and B from which no data is available in field trial data that was used for training the model. In another example, the set of possible experiment plant variety selections comprise of plant varieties A and B from which no data has been used when training the plant growth model data, that is the data set of plant growth data does not contain any data related to the plant varieties A and B. In such an example, the plant growth model can make predictions for plant varieties A and B based on plant variety parameters that describe genetics of the plant varieties.

Optionally, the set experimentation alternatives are accompanied by experiment alternatives data. In an example, genetic information such as SNPs (single nucleotide polymorphisms) is available for the set of possible experiment plant variety selections. In another example, the set of possible experiment environment selections comprises fields in different locations and the experiment alternatives data contains measurements of the third set of environmental parameters describing the soil and microclimate in the different locations. In another example, the experiment alternatives data comprises predicted distributions of the environmental conditions (of the values of the third set of environmental parameters) describing the soil and microclimate in the different locations for field trials. In a further example, the experiment alternatives data comprises the ranges of the first set of environmental parameters that can be set as the environmental conditions in the test area.

The method comprises obtaining a trained plant growth model comprising plant growth model parameters. Throughout the present disclosure “trained plant growth model” comprises a plant growth model whose parameter values have been trained. Optionally, obtaining a trained plant growth model comprises obtaining a data set of plant growth data and training the plant growth model with the obtained set of plant growth data.

The method comprises defining an experimental design utility function, that is used to formulate the cost function that can be optimised in Bayesian experimental design to create an experimentation plan. The experimental design utility function is a mathematical function that is used to formulate a cost function in an optimization task when creating the experimentation plan. In Bayesian experimental design, the experimentation plan is selected based on the cost function that is the typically the expected value of the experimental design utility function. In an example, the gain in Shannon information is used as the experimental design utility function and such an experimentation plan is selected (often referred to as the design in Bayesian experimental design literature) which maximises the expected gain in the Shannon information. Other examples of utility functions have been proposed in the literature and examples comprise experimental design utility functions related to Bayesian D-optimality and Bayesian G-optimality. Optionally, the experimental design utility function may furthermore take into account the output of the experiment, not just the information gain. Several alternatives for defining the utility function are available for a person skilled in the art, who is readily able to make a suitable selection of the utility function. In an example, the experimental design utility function is adopted to take into account the outcomes of the experimentation plan, such as the yield of the plant varieties tested to obtain the new plant growth data. In such an example, such an experimentation plan is selected that simultaneously provides high expected outcome and high expected information gain. In such an example, one or more trade off parameters control the relative weights of obtaining desirable performance scores for the new plant growth data and reducing uncertainty related to plant growth model parameters.

For evaluating the expected value of the experimental design utility function with different experimentation alternatives, the experimental design utility function, the trained plant growth model (that comprises a posterior distribution of the model parameters when Bayesian experimental design is used), the experimentation alternatives and the optional experiment alternatives data, optionally the environmental conditions data and optionally plant variety data are used. The experimental design utility function comprises related probability distributions, for example related to plant growth model parameters, and the expected value is obtained by integrating over the related probability distributions. In an example, the probability distributions related to the estimated distributions of the environmental conditions that may occur with the experimentation alternatives are accounted for in the experimental design utility function and obtaining the expected value comprises integration over this probability distribution. In other words, the expected value of the experimental design utility function is evaluated for all experimentation alternatives and the most valuable experiment is selected. In the case of continuous experimental designs, such as when selecting the values of the first set of environmental parameters in an environmental recipe to be implemented in the test area, the optimal values of the environmental parameters can be found by optimizing the expected value of the experimental design utility function by using techniques such as gradient descent, genetic algorithms, grid search, Bayesian optimisation and other optimisation methods.

After selecting the experimentation plan by using the trained plant growth model, the experimental design utility function, and optionally the data set of experimentation alternative conditions, the selected experimentation plan is performed. In an example, a field trial is performed at a selected location. In another example, the optimal environmental recipe will be implemented in the test area.

The new plant growth data is obtained by observing the outcomes of the experiment performed according to the selected experimentation plan and the environmental conditions that take place during the experiment. The new plant growth data comprises new environmental conditions data (comprising the values of the third set of environmental parameters or the values of the first set of environmental parameters) and new plant growth model output data.

Optionally, the plant growth model parameters are updated based on the obtained new plant growth data. This means that the parameter values are updated to take into account the new plant growth data. In an example, the data set of plant growth data and the new plant growth data is are used for training the plant growth model parameters after obtaining the new plant growth data.

Optionally, defining the set of experimentation alternatives comprises performing at least one experiment in a test area according to at least one experiment-specific environmental recipe, the environmental recipe comprising values of a first set of environmental parameters, and the method further comprises defining a test area, defining a plurality of spatial sub-areas within the test area, wherein within each sub-area values of the first set of environmental parameters are within a predefined range. The method further comprises planting a plurality of plants to grow within the test area, adjusting environmental conditions for the test area according to the environmental recipe, measuring the values of the first set of environmental parameters for a plurality of points in the test area to estimate the values of the first set of environmental parameters in the sub-areas. Furthermore, the method further comprises monitoring growth of the plants in the plurality of sub-areas to obtain new plant growth data. This leads to a part of the new plant growth data.

Optionally, the method further comprises defining a target environment, obtaining target environment data and using the target environment data in selecting the experimentation plan. The experimentation plan may be selected in combination with the experimental design utility function, the set of experimentation alternatives, the data set of experimentation alternative conditions and the experimentation objective. In an example, the target environment is obtained from a data base comprising historical climatic data, historical soil measurement or historical satellite images from the target environment comprising values of the second set of environmental parameters. The target environment data can be acquired from third parties. The target environment data is used to define the environmental conditions, under which new plant growth data is to be obtained to maximise information gain in terms of the target environment. In such a case, the experimentation objective is related to the target area. For example, the experimentation objective is to get new plant growth data related to performance scores of specified plant varieties particularly in the target area. In an example, the posterior uncertainty related to plant growth model parameters has a varying effect on the posterior uncertainty related to predicted performance under different environmental conditions. For example, the posterior predictive distribution of the selected performance score (comprising phenotype traits such as yield) of the plant varieties under rainy conditions has more variance than the posterior predictive distribution the same performance score under dry conditions. In such an example, if rainy and dry conditions are equally likely to occur in the target environment based on the target environment data, reducing uncertainty related to the performance score under rainy conditions can be given a higher emphasis in the experimentation plan. In other words, the experimentation objective is to minimize the uncertainty in predictions for performance scores particularly in the target area and this is encoded in the experimental design utility function by giving a higher weight for reducing uncertainty related to performance scores under conditions that are likely in the target area. When selecting the experimentation plan by optimising the expected value of the experimental design utility function, the selected experimentation plan will take into account the relevance of the obtained new plant growth data considering the environmental conditions in the target area. The target environment data is used to create an experimentation plan that reduces posterior uncertainty particularly under the environmental conditions that are likely to occur in the target environment.

Optionally, the set of experimentation alternatives comprises performing field trials in different locations. Field trials are the main form of data production in conventional plant breeding. In an example, several alternative locations and several alternative management options are available for performing the field trials. The location of the field trial can be selected and agronomic choices related to, for example, amount of fertilisation applied, can be made, as is readily known by a person skilled in the art.

Optionally, the set of experimentation alternatives comprises combinations of experiments and the experimental design utility function evaluates the combinations of experiments. For example, the experimental design utility function may take into account that several experiments are performed simultaneously. The experimental design utility function can be used to compare the expected outcomes of combinations of experiments with the expected outcomes of other combinations of experiments and the expected outcomes of individual experiments such as field trials in single locations and experiments in the test area. Throughout the present disclosure, the term “combinations of experiments” refers to an experimentation plan that comprises performing several experiments simultaneously, such as field trials and experiments performed in the test area. In an example, the experimentation plan is a combination of experiments that comprises performing four field trials at locations in Southern Europe, Northern Europe, Western Europe and Eastern Europe. The experimental design utility function is constructed to take into account the outcomes of the combination of experiments. In this way, for example, the environmental conditions (comprising the microclimate and soil properties) at different field trial locations included in the combinations of experiments can be taken into account to select combinations of experiments, where the experimentation objective is served as well as possible by the combination of the experiments. In a further example, the combination of experiments comprises of field trials in locations A, B and C and experiments in the test area with environmental recipes D and E.

According to an embodiment, at least one environmental recipe is adjusted to provide heterogeneous environmental conditions in the test area to expose the plurality of plants to gradients of environmental conditions. According to another embodiment, the at least one environmental recipe is based on identified environmental conditions observed in at least one historical experiment that characterise and differentiate performance of different plant varieties.

Optionally, the method comprises defining a plant variety of interest, selecting a performance score and selecting target environmental parameter values comprising values of a second set of environmental parameters based on the monitored growth of the plants. Throughout the present disclosure, the term “plant variety of interest” relates to a particular plant variety. The experimentation objective is thus then to estimate the performance of the plant variety of interest in the target environment. In an example, the experimentation objective is to estimate the yield of variety A as compared with varieties B, C and D in the target environment of Southern France. In another example, the experimentation objective is to estimate the taste of apple variety A as compared with apple varieties B, C and D in the target environment of Northern Poland.

The method may further comprise updating model parameters with the obtained new plant growth data, obtaining an estimate of the performance score in the target area for the plant variety of interest and using the performance score of the plant variety of interest in the target environment.

Optionally, the experimentation objective is to reduce uncertainty about the plant growth model parameters. In this case, the experimental design utility function is then derived from the posterior distribution of the plant growth model parameters according to some of the common approaches of Bayesian experimental design, as are known to those skilled in the art.

It is also possible that the new plant growth data comprises growth traits estimated based on changes of phenotype traits over a period of time.

Optionally, the experimentation objective is to improve connectivity within the data set of plant growth data by mimicking the environmental conditions observed in the data set of plant growth data in the in the test area. The environmental conditions that were observed in a historical field trial recorded in the data set of plant growth data are reproduced in the test area to evaluate how plant varieties that were not in the historical field trials would have performed there. Connectivity increases when a set of plant varieties are tested in an increasing number of varied environmental conditions. As a counter example, a data set where the plant varieties tested in different environmental conditions are not the same has poor connectivity.

The present methods comprise or may comprise defining a test area. Throughout the present disclosure, the term “test area” used herein relates to a given area in a manner that the growth of the plant variety is tested thereon. Specifically, the environmental conditions in the test area can be partially or fully controlled, thereby making it suitable for growing the plant variety according to one or more environmental recipes, the environmental recipes which define the objective values of one or more environmental parameters of the first set of environmental parameters. The first set of environmental parameters encode the environmental conditions during the growth when testing in the test area. In an example, the test area may have homogenous environmental conditions, maintaining substantially similar environmental parameters within the test area with relative differences of for example less than 10% in the environmental parameter values within the test environment that are defined in one environmental recipe. In another example, the test area may exhibit heterogeneous environmental conditions, maintaining substantially different environmental parameters within the test area so that the conditions in which the plants grow within the test area vary significantly, corresponding to having more than one environmental recipe for the test area. In an example, the test area may be a hydroponically managed greenhouse environment. In another example, the test area is a field in Southern France where additional illumination in the evenings is provided with LEDs to enable growing plants that require a longer photoperiod and all other environmental conditions are used as they appear in the field.

The methods comprise or may comprise planting a plurality of plants to grow within the test area. In an example, the plurality of plants may be of a single given plant variety. In such an example, wheat of a single variety may be planted within the test area. In another example, the plurality of plants may include different plant varieties with different genotypes and phenotypic characteristics like grain size, colour, texture, water retention, gluten content and the like. In an example, the plurality of plants comprises plant varieties of different plant species such as barley and wheat.

The methods comprise or may comprise adjusting the environmental conditions in the test area according to an environmental recipe.

Throughout the present disclosure, the term “environmental parameters” used herein relates to environmental conditions (namely, parameters). Environmental parameters can be measured to obtain values for the parameters. The environmental parameters relate to biotic and abiotic factors that affect the growth and development of plants. In an example, the abiotic factors may include information related to ambient environmental temperature, nutritional value of soil, ambient light intensity, and so forth. In another example, the abiotic factors may include information related to topography the growing medium such as soil, soil type, soil content, concentrations of minerals in irrigation water and the like. In another example, the biotic factors may include disease pressure by a chosen pathogen. In an example, the environmental parameters also contain agronomic management practices and agronomic management parameter values, such as sowing depth. Optionally, the first set of environmental parameters comprises at least one of air temperature, air humidity, soil temperature, soil humidity, radiation intensity, radiation spectrum, carbon dioxide concentration, precipitation, nutrient availability, wind speed and wind orientation. Optionally, environmental parameters are measured as time series. In an example, the average air temperature at ground level on the first day after sowing is one environmental parameter and the average air temperature at ground level on the second day after sowing in a second environmental parameter. In a further example, the environmental parameters may further comprise the type of soil such as alluvial soil or red soil. In a further example, the environmental parameter values may be defined for each growth stage; for example, for germination, vegetative, reproductive and ripening. In an example, the environmental parameters comprise agronomic management decisions such as the amounts of fertilizer used, sowing density and the timing of applying herbicides. In an example, the environmental parameters comprise satellite images of fields.

Throughout the present disclosure, many different sets of environmental parameters are defined. The parameters comprised in the different sets of environmental parameters may be the same or different. Optionally, the values of the parameters in one set of environmental parameters may be estimated from the values in another set by using a mathematical model, a statistical model and/or a machine learning method. In an example, the environmental parameter “daily average temperature at canopy level” is a part of all sets of environmental parameters. In another example, the second set of environmental parameters comprises satellite images and the first set of environmental parameters comprises soil temperature and machine learning and another external data set is used to estimate soil temperature from the satellite images. Estimating the values of environmental parameters from other environmental parameters may be performed according to methods known as such to a person skilled in the art.

Throughout the present disclosure, the term “first set of environmental parameters” used herein relates to environmental conditions (namely, parameters) under which the plants grow in the test area. In an example, the first set of environmental parameters comprises daily average temperature and air humidity within the test area. In another example, the first set of environmental parameters comprises daily temperature and disease pressure induced by contaminating the test area with the chosen pathogen, the disease pressure parameter being measured as the number of pathogens being released into the test environment.

Throughout the present disclosure, the term “environmental recipe” relates to objective environmental conditions that are encoded as values of the first set of environmental parameters. Optionally, the environmental recipe is encoded as ranges of the values of the first set of environmental parameters. In order to adjust environmental parameter values according to the environmental recipe, adjustments and regulations are performed and an adequate assistance is provided. In an example, the environmental recipe according to which a plant variety is grown in the test area is as follows during the first three weeks after sowing: wind speed is low (2 m/s during day time), lighting corresponds to dwindled sunlight (reproducing the intensity and spectrum of dwindled sunlight within the test area), an immense amount of nutrients is available. In such an instance, the environmental conditions are regulated or adjusted to fulfil the requirements to a sufficient extent. The environmental recipe covers the entire growing season, however, for the sake of brevity, only the first three weeks are described in the current example. In another example, the environmental recipe defines time series for climatic conditions (daily values for temperature and humidity). In a heterogeneous environment, the environmental recipe will be different in different parts of the test area.

In an example, the environmental recipe for growing a rice variety may include hot and moist environment with the temperature ranging between 16-27° C. between night and day during the entire growing season along with a total rainfall of 150 cm accumulated evenly on the first days of all weeks of the growing season. In such an example, the environmental recipe may further comprise the type of soil such as alluvial soil or fertile river basin soil. The environmental recipe may further describe the growing medium as layers of soil with different decompositions. In another example, the environmental recipe for growing a maize variety may include hot and moist conditions with a range of 21-27° C. between night and day and a total rainfall of 100 cm according to a time series measured in a field in Southern France.

Throughout the present disclosure, the term “environment manipulator” refers to instruments that can be used to manipulate and control the environmental conditions, measured as values of the first set of environmental parameter values.

Optionally, the environmental conditions are adjusted to provide heterogeneous environmental conditions in the test area to expose the plurality of plants to gradients of environmental conditions. For example, gradients of one or more of environmental conditions can be created within the test area. Notably, the heterogeneous environmental conditions relate to maintaining varying environmental conditions, measured as the values of the first set of environmental parameters, within the test area. It may be contemplated that the data obtained by measuring plant growth in heterogeneous environmental conditions can be used to estimate plant growth model parameters more efficiently than measurements from homogenous conditions, which do not provide variation. In such a case, the values of the second set of environmental parameters, for example, such as air temperature and air humidity, soil temperature and soil humidity, radiation intensity may have substantially different values within the test area. Furthermore, using the present method, fewer environment manipulators, selected from light emitting diodes, irrigation sprinklers, temperature controllers and air blowers are required to maintain the heterogeneous environment condition. For example, eight light emitting diodes may be required to maintain the radiation intensity within the test area within a range of 50-150% of the average radiation intensity within the test area; whereas it may be noted that to maintain a radiation intensity within the test area within a range of 80-120% of the average radiation intensity, sixteen light emitting diodes may be required. Beneficially, the cost of adjusting the environmental parameters within the test area can be substantially reduced by not requiring homogeneous environmental conditions. The present method of controlling the environment with fewer instruments that adjust the environmental parameters, measuring the induced gradients and using the induced environmental condition gradients for creating variation in plant growth is a cheaper and a more efficient way of learning the parameters of the plant growth model.

Optionally, the environmental recipe is based on identified environmental conditions observed in one or more historical experiments. In an example, the values of a third set of environmental parameters that characterize and differentiate performance measured as yield of different plant varieties in some earlier field trial may be recreated in some sub-areas when the first and third sets of environmental parameters are the same. In another example, the values of the third set of environmental parameters observed in the historical experiments in field trials may be used to estimate corresponding values of the first set environmental parameters to be used in the environmental recipe (when the first and third sets of environmental parameters are not the same). The results obtained within the test area can be substantially similar to field trials that were used as the specification. Therefore, the results might even be backwards compatible, thereby allowing the inclusion of new varieties into historical trials. Optionally, the historical experiments, whose conditions are mimicked are obtained from a database of field trials, possibly provided by a third party. More optionally, the historical experiments, whose conditions are mimicked, have been performed in the test area.

In an example, a data processing arrangement may be operable to store the data comprising of the values of the various sets of environmental parameters, the phenotype data and the plant variety data. In another example, a third party may be employed to acquire data related to the various sets of environmental parameters. In such a case third party may be a computer device or a server.

Throughout the present disclosure, the term “machine learning techniques” refers to computational methods from the field of computer science that process data to learn patterns, probability distributions and dependencies within the data. Furthermore, the machine learning techniques are configured to apply knowledge and can adapt itself and learn to do better in changing environments based on data.

Machine learning techniques in the context of the present disclosure relate to software-based algorithms that are executable upon computing hardware and are operable to adapt and adjust their operating parameters in an adaptive manner depending upon information that is presented to the software-based algorithms when executed upon the computing hardware. Optionally, the machine learning techniques include neural networks such as recurrent neural networks, recursive neural networks, feed-forward neural networks, convolutional neural networks, deep belief networks, and convolutional deep belief networks; self-organizing maps; deep Boltzmann machines; and stacked de-noising auto-encoders, kernel methods, linear and non-linear regression methods and clustering methods. A “neural network” as used herein can include a highly interconnected network of processing elements, each optionally associated with a local memory. In an example, the neural network may be Kohonen map, multi-layer perceptron and so forth. A neuron can receive data from an input or one or more other neurons, process the data, and send processed data to an output or yet one or more other neurons. The neural network or one or more neurons thereof can be generated in either hardware, software, or a combination of hardware and software, and the neural network can be subsequently trained.

Optionally, machine learning techniques may employ any one or combination of the following computational techniques: constraint program, fuzzy logic, classification, conventional artificial intelligence, symbolic manipulation, fuzzy set theory, evolutionary computation, cybernetics, data mining, approximate reasoning, derivative-free optimization, decision trees, or soft computing.

Optionally, the values of the first set of environmental parameters are adjusted using environment manipulators, optionally selected from light emitting diodes, irrigation sprinklers, temperature controllers and air blowers. In an example, properties of the growth medium, such as soil temperature and moisture at different depths (when growing in soil) and temperature of water (when growing plants hydroponically) are adjusted with environment manipulators. Environmental conditions are adjusted according to the environmental recipe. Furthermore, the adjustment of the environmental conditions is acquired by implementation of various equipment such as environment manipulators for regulating the precipitation rate, including light emitting diodes to maintain lighting conditions, irrigation sprinklers for producing rain-like irrigation across the test area, temperature controllers and air blowers to regulate the ambient temperature. In an example, the availability of light to the plants may be adjusted by varying the position of the plant, for example vertical position of the pot holding the plant and the position of the light source. Optionally, the light source can also move vertically to simulate the movements of the sun.

Optionally, a control arrangement may be employed to control the operation of the aforesaid environment manipulators. Throughout the present disclosure, the term “control arrangement” as used herein relates to a system or assembly that contains peripheral devices or components required for receiving signals for operation of the sensors, and transmittance or communication of sensor data.

The method comprises measuring the environmental parameters for the plurality of points in the test area to estimate the values of the first set of environmental parameters in the sub-areas. Throughout the disclosure, the term “plurality of points” used herein relates to given points (namely, spatial locations) within the test area. Notably, each point has values of the first set of environmental parameters associated therewith.

Optionally, the values of the first set of environmental parameters are interpolated and extrapolated for other points in the test area. In other words, the values are measured for a subset of points within the test area and mathematical models, statistical models and/or machine learning methods are used to predict the values of the first set of environmental parameters for the points, for which no measurement is available, according to methods known as such to a person skilled in the art.

The method comprises or may comprise defining spatial sub-areas within the test area. Throughout the present disclosure, the term “sub-area” used herein relates to a region (namely, an area) within the test area in a manner that the first set of environmental parameter values within each sub-area are substantially similar. Notably, at each time point, each sub-area has a first set of environmental parameter values within a predefined range. Variation in the values one or more parameters of the first set of environmental parameters within a sub-area is lesser than the variation in the values of the same parameters between the different sub-areas. It may be understood that the defined sub-areas upon combination form the complete test area. In an example, the test area may be operable with temperature in a range of 2 to 8° C. In such an example, a point A may have a temperature of 3° C., a point B may have a temperature of 6° C., and a point C may have a temperature of 8° C., where A relates to a first sub-area, B relates to a second sub-area and the C relates to a third sub-area. Notably, the sub-area relates to the growing environment of one or more plants, encoded as the values of the first set of environmental parameters. In an example, the sub-areas are defined as the growing environment of individual plants. Within each such sub-area, first set of environmental parameters comprise temperature at ground level, temperature at 15 cm above ground and temperature 30 cm above ground. Also, the environmental conditions within several sub-areas may be the same for the purpose of having different plant varieties in the several sub-areas. Within one sub-area, the environmental conditions are similar as compared to differences between the environmental conditions in different sub-areas.

Optionally, defining the sub-areas is based upon the values of the first set of environmental parameters. The first set of environmental parameters may relate to soil content, air content, temperature, humidity and the like. When a plurality of points have similar environmental parameter values, they may be defined as sub-areas within the test area. Furthermore, the sub-areas can also be defined on the basis of the values of the first set of environmental parameters related to stress factors in the sub-areas. In such a case, the plurality of points within the test area having similar stresses may be defined as sub-areas. Examples of tolerances may include, but are not limited to, biotic stresses (disease pressure) and tolerance to abiotic stresses for example such as, drought, heat, flooding, frost and the like. It is thus possible to either define the sub-areas before any measurement is carried out, or to define the sub-areas based on the measured values of environmental parameters.

Optionally, the values of the first set of environmental parameters for the plurality of points in the test area are measured by sensors, comprising at least one of light sensors, temperature sensors, precipitation sensors, air content sensors and soil content sensors. The term “sensors” used herein relates to a device that detects (and possibly responds to) signals, stimuli or changes in environmental parameters of a given system, or the environment in general, and provides a corresponding output. The output is generally a signal that can be converted to human-readable display at the sensor location or transmitted electronically over a network for reading or further processing. Additionally, the sensor may include any device which can provide a form of perceived perceptual information.

It will be appreciated that the adjustment of the environmental conditions according to the values of the first set of environmental parameters defined in the environmental recipe requires acquiring appropriate information about the environmental conditions (measured as the first set of environmental parameter values) at the plurality of points in the test area. The measurement of such environmental parameter values is obtained by locating various sensors (such as light sensors, temperature sensors, precipitation sensors, air content sensors and/or soil content sensors) at plurality of points in the test area. Additionally, the sensors located at plurality of points in the test area may provide adequate information about the first set of environmental parameters at regular intervals (such as days, weeks, months and so forth). In an example, the sensors may provide information about the ambient temperature, wind speed, humidity, nutritional value of soil, and so forth, at plurality of points in the test area.

Optionally, a sensor arrangement may be employed to control the operation of the aforesaid sensors. Throughout the present disclosure, the term “sensor arrangement” as used herein relates to a system or assembly that contains sensors and if necessary, any other peripheral devices or components required for operation of the sensors, and transmittance or communication of the sensor data. Additionally, the sensor arrangement includes any device which can provide a form of perceived perceptual information. Furthermore, the devices may be operable to provide visual, auditory, tactile (e.g., touch, pressure), olfactory (e.g., smell), balance, or any combination of these perceptual informations. In an example, the data processing arrangement may be communicably coupled to the sensor arrangement and the control arrangement.

The method comprises monitoring growth of the plants in a plurality of the sub-areas. Notably, each sub-area has values of the first set of environmental parameters at a predefined range. The environmental conditions, measured as the first set of environmental parameter values, may be different in different sub-areas and plant growth data from different environmental conditions will be generated. To understand the impact of the environment on the plants, the growth of the plants can be monitored in one or more sub-areas. Furthermore, monitoring of growth of the plant includes monitoring of various plant phenotype traits. Additionally, monitoring growth of the plants may involve measuring phenotype traits such as height of the plant, number of tillers, number of leaves, number of seeds, texture, time taken to grow of leaves, branches and fruits, and so forth. In one example, growth of wheat plants is examined. In such a case, the height of the plants in a certain sub-area increases during the growing season and finally reaches 42 cm and in that sub-area, the plants have on average 10 seeds in each spike at the end of the growth period. When the test area has heterogeneous environmental conditions, different sub-areas will have different environmental recipes.

According to an embodiment, the growth of the plants is estimated as phenotype traits comprising at least one of number of seeds, size of seeds, yield, leaf area, plant height, response to heat stress, structural traits, time periods needed to reach different developmental stages, roots traits, and nutrient concentrations within the plant. The growth of the plants may for example be further estimated based on the changes of the phenotype traits over a period of time.

The term “phenotype traits” used herein relates to a set of observable and measurable traits (namely, characteristics) that result from the plant genotype, environmental effects and interaction of the plant genotype with the environment. Examples of phenotype traits comprise number of seeds, size of seeds and shape of seeds, leaf area and leaf shape, plant height, structural traits, time periods needed to reach different developmental stages, root traits, nutrient concentrations and other chemical concentrations within the plant and physical properties of the plant. Further examples of phenotype traits comprise yield measurements, protein content measurements from field trials and gene expression measurements in laboratory conditions. Optionally, the phenotype traits can be temporal changes of phenotype traits. In other words, phenotype traits can be measured as a function of time and the properties related to the change are considered the phenotype observation (for example, changes in leaf area and changes in leaf colour). Additionally, changes in phenotype traits as responses to environmental conditions (for example, change in leaf colour as a function of temperature stress) are considered phenotype traits. Additionally, changes in phenotype traits as a function of time and the environmental conditions are considered phenotype traits (growth speed parameters as a function of environmental parameter values). Additionally, comparison scores of phenotype traits obtained by comparing phenotype trait values to the phenotype trait values of some specified plant varieties are considered phenotype traits. In an example, yield of all other varieties is measured by comparing it to the yield of variety A by subtracting the yield of plant variety A from the yields of all other varieties.

In another example, phenotype trait values are obtained by dividing the yields of all plant varieties by the yield of plant variety A to obtain a comparison score, that is used as a phenotype.

Throughout this disclosure, the measuring of the growth of plants refers to observing the values of phenotype traits of the plants. Throughout this disclosure, “growth traits” refer to phenotype traits. Throughout this disclosure, “monitored growth of plants” refers to observed growth, measured as phenotype traits. Optionally, the values of a phenotype trait corresponding to a single trait measured from field trials and measured from the test area are considered different phenotype traits. In an example, “yield measured in the test area” is a different phenotype trait than “yield measured in a field trial”.

For instance, plant phenotype traits can be measured on for example daily basis, thereby creating a time series related to change of the phenotype traits over the period of time. In one example, the phenotype trait such as, plant height may be examined. For instance, initially the plant height may be 30 cm and over the periods of time the plant will grow to 35 cm; and, in such case, the time period taken for achieving the said growth may be measured. In another example, indirect changes in electrical conductivity of roots of a plant may be measured, thereby estimating the variation of the plant phenotype traits (for example, root traits). In yet another example, X-ray imaging may be employed to estimate variation in the root traits of the plants.

Optionally, the growth of the plants is estimated as phenotype traits or based on variations of the phenotype traits over periods of time. Furthermore, optionally, observations of a phenotype trait such as yield obtained from field trials and yield obtained from a test area are considered different phenotype traits. This is useful, as the plant growth model may use phenotype trait data directly as input for predicting other phenotype traits. Optionally, when plants are grown in pots, they can be moved outside the test area for analysis of phenotype traits.

Throughout the present disclosure, the term “plant growth model” used herein relates to a specialized mathematical model, deterministic crop model, statistical model or generally machine learning techniques used for predicting the growth of a given plant variety. When plant growth model is given as input values of plant variety parameters and values of the fourth set of environmental parameters, the plant growth model outputs predictions for a first set of phenotype traits, the predictions which comprise numerical values, classifications, statistics and probability distributions of the numerical values, classifications and/or graphs. Throughout this disclosure, the term “plant growth model input parameters” comprise the fourth set of environmental parameters and the plant variety parameters. In an example, the phenotype traits predicted by the plant growth model include yield (measured as tonnes/hectare), disease susceptibility, structural traits and the like.

The values of the plant growth model input parameters (fourth set of environmental parameters and plant variety parameters) used for generating the predictions for phenotype traits may be taken from at least one of the target environment data (comprising values of the second set of environmental parameters), environmental condition data from field trials (comprising values of the third set of environmental parameters) and environmental condition data from the test area (comprising values of the first set of environmental parameters) and from the plant variety data. Optionally, when the different sets of environmental parameters do not contain the same parameters, the values of the parameters in one set may be estimated based on the values of some other parameters in the other sets of environmental parameters. Furthermore, the fourth set of environmental parameters may contain all the parameters that are included in the first, second and third set of environmental parameters. It is emphasized that the plant growth model can be implemented in various ways but the critical aspect is that the plant growth model can be used to process the environmental data from different sources (field, test area, target environment) into predictions of phenotype traits in the different areas. Optionally, additionally, the plant growth model also uses phenotype trait measurements from different sources (field, test area) as input when predicting the values of other phenotype traits. It is thus possible to combine the information obtained with the different methods described, in order to obtain the desired result.

The plant growth model comprises parameters and the plant growth model parameters control how the predicted values of the phenotype traits are affected by the values of the plant growth model input parameters.

The values of the plant growth model parameters are defined by training the model with a data set of plant growth data to obtain a trained plant growth model. Several techniques for training the values of the plant growth model parameters are available and those skilled in the field of machine learning are readily able to carry out the training. In an example, the data set of plant growth data is not needed for generating predictions from the values of plant growth model input parameters with the trained plant growth model (e.g. when the plant growth model comes from the model family of linear regression models). In another example, the data set of plant growth data is needed for generating predictions from the values of plant growth model input parameters with the trained plant growth model (e.g. when the plant growth model comes from the model family of kernel methods).

Throughout this disclosure, the term “uncertainty about the plant growth model parameters” relates to statistical and other methods for evaluating the uncertainty of estimates numerically. Optionally, the plant growth model is a Bayesian statistical model and posterior distributions for the values of the plant growth model parameters are available. In such a case, uncertainty about the plant growth model parameters relates to scores used for measuring uncertainty in the Bayesian paradigm, such a posterior variance of the plant growth model parameter distributions. Optionally other frameworks that enable measuring uncertainty of plant growth model parameter values are used. In another example, uncertainty is measured by using bootstrapping to estimate the variance of the estimates of the plant growth model parameters. Several computational alternatives for measuring uncertainty related to parameter estimates are available and have been presented in the statistical and machine learning literature.

The data set of plant growth data comprises data from past experiments (field trials, experiments performed in the test area and laboratory measurements). The data set of plant growth data typically comprises a plurality of pairs of plant growth model input data and plant growth model output data. The plant growth model output data comprises measurements (realised values) of the one or more phenotype traits that the plant growth model predicts based on the plant growth model input parameters. The plant growth model input data encodes the information about the experiment, the experiment in which the phenotype traits (the plant growth model output data) were observed comprising plant variety data and environmental condition data. Throughout this disclosure, the term “plant variety data” comprises the values of “plant variety parameters” such genetic markers, genomic sequences, genealogy, pedigree information and/or other information related to the characteristics of plant varieties. In an example, the plant variety data comprises values of plant variety parameters that are identifiers for the different plant varieties for which plant growth model output data is available in the data set of plant growth data so that each phenotype trait value in the plant growth model output data can be mapped to a particular plant variety. In another example, the plant variety data comprises the values of plant variety parameters that comprise values of genetic markers for single nucleotide polymorphisms for the different plant varieties, for which plant growth model output data is available. Throughout this disclosure, the term “environmental condition data” comprises values of a set of environmental parameters that describe the environmental conditions, conditions in which the one or more phenotype traits were measured. Optionally, the data set of plant growth data may comprise scientific literature, from which plant growth model parameter values are taken from. Optionally, the plant growth model input data comprises further plant variety data, further environmental conditions data and further plant growth model output data. Optionally, the plant growth model input data comprises a second set of phenotype trait measurements and the plant growth model predicts the values of the first set of phenotype trait measurements with input data comprising the measured values of the second set of phenotype trait measurements. In an example, yield measurements in the test area (second set of phenotype trait measurements) are used as input when predicting yield measurements in a field trial (first set of phenotype trait measurements).

Optionally, the plant growth model is used for predicting performance scores. In such a case, the plant growth model first predicts the values of the phenotype traits that are used to estimate the value of the performance score.

In an example, the plant growth model is trained with a data set of plant growth data obtained from field trials. To predict performance scores in the target area for a set of plant varieties, target environment data (values of the second set of environmental parameters) and plant variety data (values of plant variety parameters for the plant varieties whose performance scores are to be predicted) are used as input to the plant growth model, from which input the plant growth model will then output the predictions of phenotype traits in the target environment. The predicted phenotype traits can then be processed into predicted performance scores. If the second set of environmental parameters and the fourth set of environmental parameters are not the same, the values of the fourth set of environmental parameters may be estimated from the values of the second set of environmental parameters. In an example, plant variety data comprises the values of plant variety parameters that contain genetic information and the plant growth model may be trained with a data set of plant growth data obtained from the test area consisting of data for set A of plant varieties and used to predict phenotype traits in the target area for set B of plant varieties, where the plant varieties in groups A and B may be non-overlapping or partly overlapping.

Optionally, the growth of the plants is monitored by image processing for measuring characteristics of the plants in the plurality of the sub-areas. The characteristics are typically phenotype traits of the plants in the plurality of the sub-areas. The term “image processing” used herein relates to specialized techniques employed for analysis and manipulation of a given image. In such a case, the phenotype traits of the plant variety for example, such as size of seeds, yield and the like are monitored by taking images of the plants and processing the images into estimates of the phenotype traits. Optionally, the phenotype traits can be based on spectral characteristics of the plants. In an example, the image processing technique may be employed to measure the phenotype trait quantitatively through interaction between light and the plant such as reflected photons, absorbed photons or transmitted photons. In such an example, each component of the plant cells and tissues has wavelength-specific absorbance, reflectance and transmittance properties. For instance, chlorophyll may absorb photons primarily in blue and red spectral region of visible light, water has its primary absorption features in the near and short wavelengths and cellulose absorbs photons in a broad region between 2200 and 2500 nm. In another example, the image processing techniques can be employed to collect data for quantitative study of phenotype traits related to the growth, yield and adaptation to biotic or abiotic stress (growth under disease, stress caused by insects, growth under drought and/or salinity). Furthermore, examples of imaging processing techniques may include visible imaging (machine vision), imaging spectroscopy, thermal infrared imaging, fluorescence imaging, 3D imagining and the like. Beneficially, cost of measurement of the plant phenotype trait is substantially reduced by employing such image processing techniques.

Optionally, the image processing techniques may employ digital cameras, laser sensors, time-of-flight cameras and the like for capturing images. Beneficially, the camera may be employed to capture images from different views, for example such as top view, side view and the like, thereby allowing better analysis of spectral properties of the plants. Additionally, image data can be processed using data processing techniques.

More optionally, the method comprises spreading the plants to capture images, video or bursts of several images of the plants below top portions thereof. Notably, the image data is combined with various mechanical tools that spread the plants in such a manner that the parts of the plant below topmost layer of the plants are captured. Air blowers can also be used. Such mechanical tools may be readily contemplated by a person skilled in the art. More optionally, the method comprises spreading the plants in field conditions to capture images, video or bursts of several images of the plants below top portions thereof. Image processing may be further processed with image processing algorithms to generate estimates of interesting structural traits. Employing image processing algorithms to process data comprising images, video and bursts of several images into interesting structural traits may be readily contemplated by a person skilled in the art.

The method comprises or may comprise selecting one or more target environmental parameter values comprising values of a second set of environmental parameters based on the monitored growth of the plants. In other words, the monitored growth is employed for finding environmental parameter values suitable for growth of the plants. In other words, the method enables identifying conditions measured as the first set of environmental parameters, that are suitable for growth of plants and uses them to select the values of the second set of environmental parameters. When the first and second set of environmental parameters are the same, the values of the first set of parameters may be selected directly. When the first and second sets of parameters are different, the values of the parameters in different sets may be converted into the values of the other. In an example, the plant growth data generated in the test area is used to infer that a plant variety that was tested suffers from daily average temperatures of less than 15° C. In this example, the second set of environmental parameters comprises geographic location of fields where the plant variety tested may be grown. The target environment data comprises weather data (further comprising daily average temperature) for the different locations and the geographic locations of the fields. In the present example, fields where the daily average temperatures are higher than 15° C. with a probability of 0.9 may be selected by selecting the values of the environmental parameter “geographic location” corresponding to such fields where favourable environmental conditions are available for the tested plant variety. In this way, the method enables selecting values of the second set of environmental parameters based on the plant growth data comprising values of the first set of environmental parameters.

The plant growth data from the sub-areas in the test area becomes a data source for the aforesaid methods, such as the plant growth model, to predict phenotype traits for the plant variety. The environmental conditions within the test area are measured accurately as the values of the first set of environmental parameters, thereby obtaining substantially accurate plant growth data from the heterogeneous environment maintained within the test area. The growth of the plant variety is monitored under a highly varying environmental conditions within the test area, the conditions measured as the values of the first set of environmental parameters. The variation in the data obtained from the heterogeneous environment comprising the estimated first set of environmental parameter values and phenotype trait measurements produced by the aforesaid method can be generalized to the field environment by using the plant growth model to estimate the values of the second set of environmental parameters that predict good performance of the plant variety. In an example, the first and second sets of environmental parameters are the same and observing the growth of plant varieties reveals environmental conditions under which the plant variety performs well. In another example, the second set of parameters are different or partly different, for example the second set of parameters comprises geographic location. The observed growth identifies conditions under which the plant can perform well (measured as values of the first set of environmental parameters) which can then be mapped to locations based on target environment data (values of second set of environmental parameters in different locations) by estimating the probability distribution of the environmental conditions that define plant performance in different locations.

Optionally, the method employs data comprising the first set of environmental parameter values from a plurality of points in the test area and using machine learning methods, statistical models and/or mathematical models for estimating the values of the first set of environmental parameters within the test area in such a plurality of points, for which measurements are not available. These pluralities of points may be different, i.e. the measurements are carried out in a first set of points and these results are used for estimating the values of the same environmental parameters in different points, i.e. in a second set of points. In this way modelling is used to reduce the number of measurements needed to estimate the conditions within the test area. This enables monitoring and adjustment of the environmental conditions within the test cost-efficiently. Machine learning methods, statistical models and/or mathematical models can be used to estimate the values of the first set of environmental parameters in sub-areas from which measurements from the values of the first set of environmental parameters are not available from sensors. The machine learning methods, statistical models and/or mathematical models are used for interpolating and extrapolating the measurements of environmental parameters. Throughout this disclosure, the terms “measure” and “measurements” comprise values obtained from sensors and estimates of the values obtained by interpolating and extrapolating by using machine learning methods, statistical models and/or mathematical models and measurements from the sensors. In an example, the test area comprises equal sized and equal shaped sub-areas A, B and C that are located consecutively on a straight line. The first set of environmental parameters comprises temperature that is measured from points in sub-areas A and C. In such a case, a linear interpolation of the temperature can be used to obtain an estimate for the value of temperature in sub-area B based on the measurements from the points in sub-areas A and C, for example by computing the average as sub-area B is located between sub-areas A and C. Optionally, the measurements from the plurality of points are obtained manually and their values are estimated at later times by using machine learning from other available sensor measurements. The methods thus use obtained measurements and estimated measurements continuously for improving the results.

Different plants perform well in different environments. In an example, the target environment for obtaining the desired growth of mango tree comprises ambient temperature in a scale of warm to hot, low rainfall, low relative humidity, deep and well-drained soil, slightly acidic soil, and so on. However, mango plant may tolerate dry conditions, waterlogging and moderately saline soil, nevertheless, the growth of mango tree grown under the latter environmental parameters is relatively poor.

It may be understood that the responses to the environmental parameter gradients in the controlled environment do not need to directly match the environmental parameter in field conditions. In the present methods, the data produced in the controlled environment can be used as inputs to a machine learning model which makes predictions for field environments. This can be achieved since measurements from gradients of environmental conditions have been obtained without which differentiating between plant variety's performance would be very difficult. The data from the controlled environment simply becomes a further data source to the machine learning or other techniques that are used to predict variety-specific performance.

Optionally, the environmental recipe can be optimized for example by using Bayesian experimental design. Given existing information from field trials and past experiments in the test area, the plant growth model can be used to estimate, which environmental recipe would reduce uncertainty about the plant growth model parameters maximally. In an example, such an environmental recipe can be selected which maximises the expected information gain.

In the present methods, the instruments that control the environment (that is, the environment manipulators such as light sources, temperature controllers, irrigation controllers, air content controllers, soil temperature controllers) are positioned in such a way that there will be heterogeneity in the environmental conditions within the environment, allowing for a lower number of control units to save costs. The plants are thus exposed to gradients of environmental conditions. Throughout the present disclosure, “gradients of environmental conditions” comprise any variation of conditions. In an example, the gradients of environmental conditions comprise temperatures of 1, 2, 3, 4 and 5° C. the sub-areas A, B, C, D and E, respectively. In another example, the gradients of environmental conditions comprise of temperature 1, −2, 4, 5 and −3° C. for the sub-areas A, B, C, D and E, respectively. Sub-area-specific estimates for phenotype traits and environmental parameter values (first set of environmental parameters) are estimated and plant growth models are used to learn, how different plants respond to varying environmental conditions by using the obtained new plant growth data to train the plant growth model parameters after which the plant growth can be used to estimate response surfaces of plant phenotype traits to the continuum of environmental parameters. This is in contrast to approaches where test areas with homogeneous environmental conditions are used to estimate the responses of multiple plants to a single environment (environmental conditions without significant variation). The environment is typically controlled so that the various different points on the continuum provide useful information about plant agronomic performance. The plant phenotype can be measured with existing techniques (imaging based but also, for example, using sensors that are attached to the plants directly). It may be understood that the proposed experimental design allows for the selection of what kinds of gradients are produced, which is critical for producing data that supports decision making for a particular target environment, for example (and selected performance scores). Herein, either environmental conditions observed in the target population of environments can be used directly, or machine learning techniques can be used to detect the set of conditions, that characterise variety performance in the target population of environments optimally.

The present methods of using gradients for the environmental parameters is a faster and more efficient way of identifying the essential parameters that impact the plant growth. This also helps with cost savings from requiring less light sources, as lightning no longer needs to be homogenous. The machine learning techniques implemented in the present methods allows for the prediction of any agronomic outcome (e.g. phenotypes such as yield, nutrition, etc.) at a particular growing environment from all available plant variety data and growing environment data. The present methods employ a non-reductionist approach to predict the summed total effect of environment, from all available data sources as desired for practical agronomic purposes, in huge contrast to most approaches that incorporate few individual stress factors. The present methods are also able to extrapolate outside the grid of field trials. That is, the present methods can be implemented to predict performance especially under conditions, which have not been sufficiently explored by the field trials and for steering the experimental design for the next growth season.

Furthermore, the present methods help to understand plant varieties' responses, including efficiency and resilience properties, and enables management that will reduce the plant's growth dependency on external inputs. The present methods further help to lower agriculture's environmental footprint and cope with more variable climatic conditions by capitalizing on the learnt response surfaces. The present methods allow maximizing yield while minimizing the inputs in each environment, and enable explicit quantification and comparison of varieties in terms of their suitability for varying conditions (even outside to the limited set of testing locations). Thereby, the present methods will help with introducing plant traits that respond to new challenges and demands in the conventional and organic sectors, while also taking into account the economic return of growers. The present methods also help with identifying crop characteristics and sustainability criteria associated with the capacity of new varieties to maintain yield under more variable conditions and under more sustainable crop management practices.

Optionally, when the growing conditions within the test area (which are encoded as the first set of environmental parameters) are heterogeneous, the environmental recipe is sub-area specific. In other words, each sub-area has a specific environmental recipe. In this way, when a plant variety is grown in several sub-areas, the plant variety will be exposed to varying environmental conditions and the performance of the plant will accordingly be recorded under several varying conditions. The resulting data enables estimating plant growth model parameters for the plant variety. It should be noted that observing the performance of the plant variety in only one environmental condition would not enable estimating the plant growth model parameters equally well.

Optionally, the present methods comprise creating at least one environmental recipe comprising values of a first set of environmental parameters based on the target environment. In an example, the target environment data related to the target environment is used to estimate probability distributions for the values of the second set of parameters, the probability distributions are then used to estimate corresponding probability distributions of the first set of parameters by estimating the values of the first set of environmental parameters from the values of the second set environmental parameters. In another example, the environmental recipe is chosen in such a way that the uncertainty related to plant growth model predictions in the target environment, based on the target environment data, is reduced as much as possible, given the set of experimentation alternatives.

An embodiment of the present disclosure provides a system for creating new plant growth data comprising a test area for growing a plurality of plants. The test area can refer to a field, a green house, closed area or volume. The test area is typically controlled environment. The test area comprises a plurality of spatial sub-areas. Each of the plurality of spatial sub-areas are under conditions of a first set of environmental parameters. Environmental parameters can be for example light, temperature, moisture level on the ground or in the air etc. The environmental parameters are within a predetermined range. The comprises environmental manipulators, the environmental manipulators are configured to adjust environmental conditions within the test area according to one or more environmental recipes. A first sensory arrangement can be configured to measure values of the first set of environmental parameters for a plurality of points in the test area to estimate the values of the first set of environmental parameters in the sub-areas. Example of the first sensory arrangement sensors can be temperature sensor, moisture sensor, illumination sensor. Further the system comprises a second sensory arrangement configured to monitor growth of the plants in the plurality of sub-areas, wherein the second sensory arrangement comprises at least one of a growth sensor or a camera. Growth sensor can be for example a height measurement sensor using infrared to detect height of grown plants, the camera can be camera configured to detect visible light and/or light outside of visible range. A server arrangement of the system is configured for storing a new plant growth data. The new plant growth data comprises at least the measured values of the first set of environmental parameters and monitored growth. The monitored growth can refer to output of the growth sensors and cameras deployed to monitor the growth of the plants.

Optionally or additionally the environmental manipulators of the system are arranged to adjust the environmental conditions within the test area to form gradients of the environmental conditions. The gradients refer to environmental conditions wherein at least a first sub area and a second sub-area have different environmental conditions from each other. The first and second sub area can be adjacent to each other or those can be arbitrary sub areas within the test area. For example amount of light (measured at top of the canopy level) in the first sub-area can be 50% from the light of the maximum in the test area. Empirically when the variation of the gradients within the test area are within ranges from 25%-70% of the maximum in the test area to the maximum in the test area, the data production is efficient. This refers to having areas for example wherein some environmental conditions change 25% to 70% between two or more test areas. When the variation ranges from less than 25% of the maximum to the maximum, the data produced was not so useful for updating the parameters of the plant growth model from many sub-areas. When the variation ranged from 75% to the maximum, the produced data did not have sufficient variation to efficiently update the parameters of the plant growth model. When variation ranges between 40% and 50% of the maximum to the maximum, the data production was found to be optimal.

The present description also relates to a system for carrying out the present methods. Typically, such system comprises a processor configured to carry out the method steps, communicatively coupled to the required databases or similar, to sensors if they are used, and to environment manipulators if used. The system may also comprise a test area, such as a field or a green house.

### DETAILED DESCRIPTION OF THE DRAWINGS

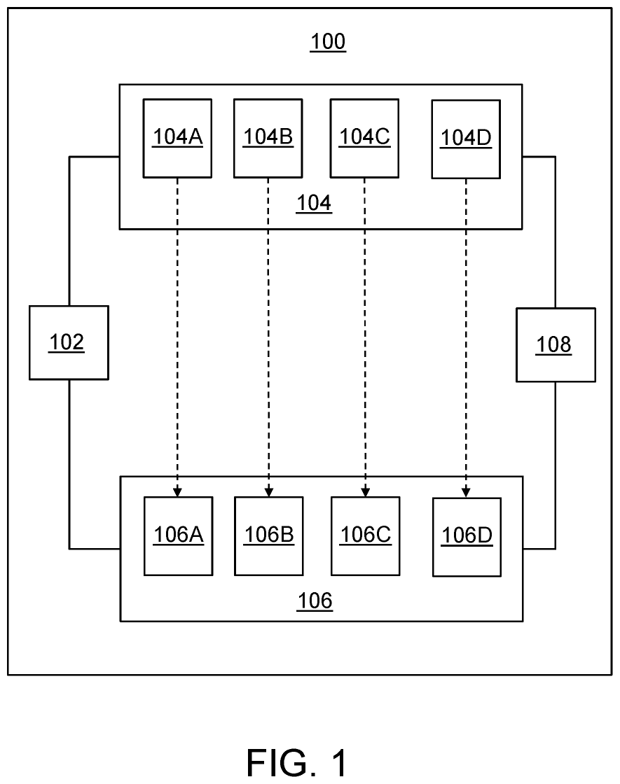

Referring to FIG. 1 is a block diagram of architecture of a system 100 for finding a target environment suitable for growth of a plant variety, in accordance with an embodiment of the present disclosure. The system 100 comprises a controller arrangement 102, a sensor arrangement 104, a regulator arrangement 106 and a data processing arrangement 108. Furthermore, the sensor arrangement 104 comprises at least one of: a temperature sensor 104A, a humidity sensor 104B, a light sensor 104C and an air content sensor 104D. Moreover, the regulator arrangement 106 comprises a temperature regulator 106A, a humidifier 106B, a light source 106C and an air blower 106D. Furthermore, the controller arrangement 102 is operatively coupled to the sensor arrangement 104 and the regulator arrangement 106, and is operable to adjust environmental parameters. Moreover, the data processing arrangement 108 is communicably coupled to the sensor arrangement 104 and the regulator arrangement 106, and is operable to measure the environmental parameters.

It will be appreciated that FIG. 1 is merely an example, which should not unduly limit the scope of the claims herein. It may be understood by a person skilled in the art that FIG. 1 include simplified arrangements for implementation of the system 100 for sake of clarity. The person skilled in the art will recognize many variations, alternatives, and modifications of embodiments of the present disclosure.

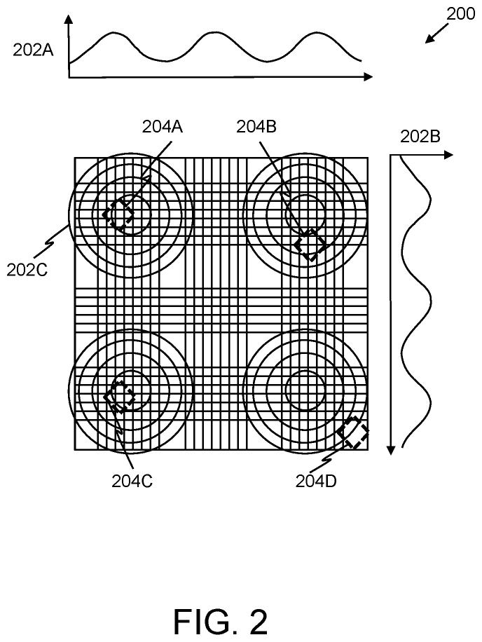

Referring to FIG. 2 illustrated is an exemplary representation of heterogeneous environmental conditions within a test area 200, in accordance with an embodiment of the present disclosure. As shown, the environmental conditions, depicted as precipitation 202A, light intensity 202B and temperature 202C, are adjusted within the test area 200. 202A shows the quantity of precipitation at different parts of the test area (the quantity of precipitation changes alternatingly when moving from left to right in the test area). 202B shows the light intensity at different parts of the test area (the intensity changes alternatingly when moving bottom to top in the illustration in the test area). 202C shows contour lines related to temperature in the test area. Furthermore, the spatial sub-areas, depicted as 204A, 204B, 204C and 204D are defined within the test area 200 based upon the set of the environmental parameters 202A, 202B and 202C within a predefined range. Furthermore, the precipitation 202A varies along x-axis and vertical contour lines denote areas with same rainfalls. Moreover, the light intensity 202B varies along y-axis and horizontal contour lines denote areas with same intensities. Furthermore, circles denote areas with similar temperature 202C. In sub-areas 204A and 204C the environmental conditions and the corresponding values of the first set of environmental parameters are notably similar. The environmental conditions and the corresponding values of the first set of environmental parameters in 204C and 204D are notably different: in 204C precipitation and light intensity are high whereas in 204D both are low.

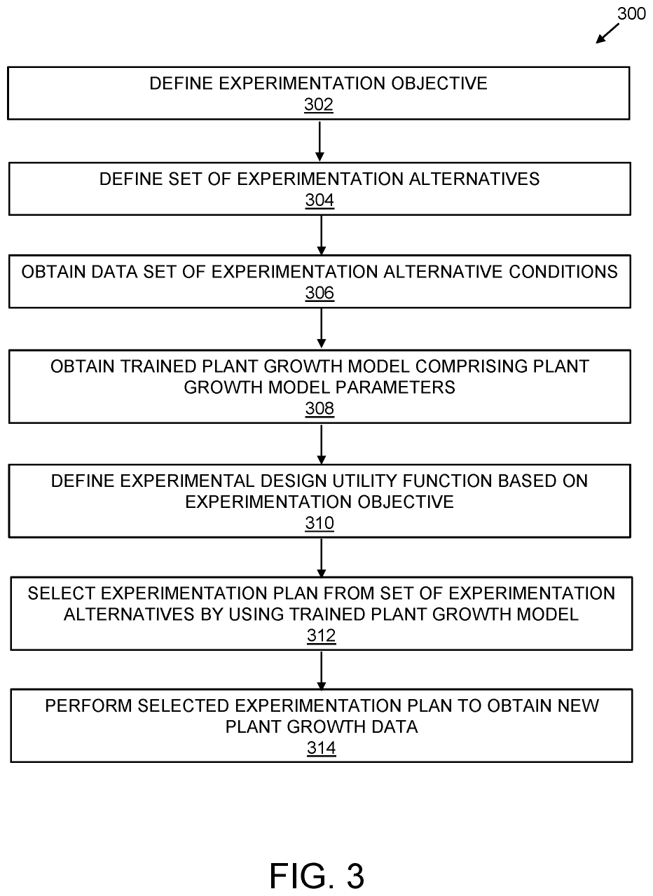

FIG. 3 illustrates steps of a method 300 for obtaining new plant growth data according to an experimentation objective, according to an embodiment of the present disclosure. At step 302, an experimentation objective is defined. At step 304, a set of experimentation alternatives is defined, and in step 306, a data set of experimentation alternative conditions is obtained. Step 308 consists of obtaining a trained plant growth model comprising plant growth model parameters and step 310 of defining an experimental design utility function based on the experimentation objective. Thereafter, in step 312, an experimentation plan from the set of experimentation alternatives is selected, by using the trained plant growth model, the experimental design utility function, and the data set of experimentation alternative conditions. Finally, in step 314, the selected experimentation plan is performed to obtain new plant growth data.

The steps 302 to 314 are only illustrative and other alternatives can also be provided where one or more steps are added, one or more steps are removed, or one or more steps are provided in a different sequence without departing from the scope of the claims herein.

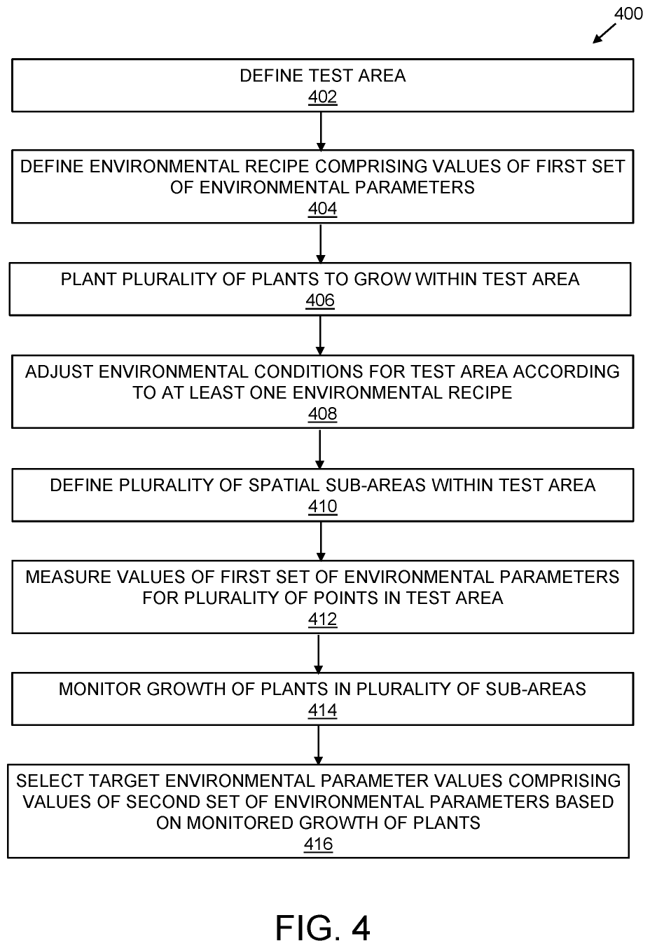

FIG. 4 illustrates steps of a method 400 of finding a target environment suitable for growth of a plant variety, in accordance with an embodiment of the present disclosure. At step 402, a test area is defined. At step 404, an environmental recipe comprising values of first set of environmental parameters is defined, and in step 406, a plurality of plants is planted to grow within the test area. At step 408, environmental conditions are adjusted for the test area according to at least one environmental recipe. At step 410, plurality of spatial sub-areas are defined within the test area, and in step 412, values of the first set of environmental parameters are measured for the plurality of points in the test area. At step 414, growth of the plants is monitored in a plurality of the sub-areas. At step 416, target environmental parameter values are selected, comprising values of second set of environmental parameters based on the monitored growth of the plants.

The steps 402 to 416 are only illustrative and other alternatives can also be provided where one or more steps are added, one or more steps are removed, or one or more steps are provided in a different sequence without departing from the scope of the claims herein.

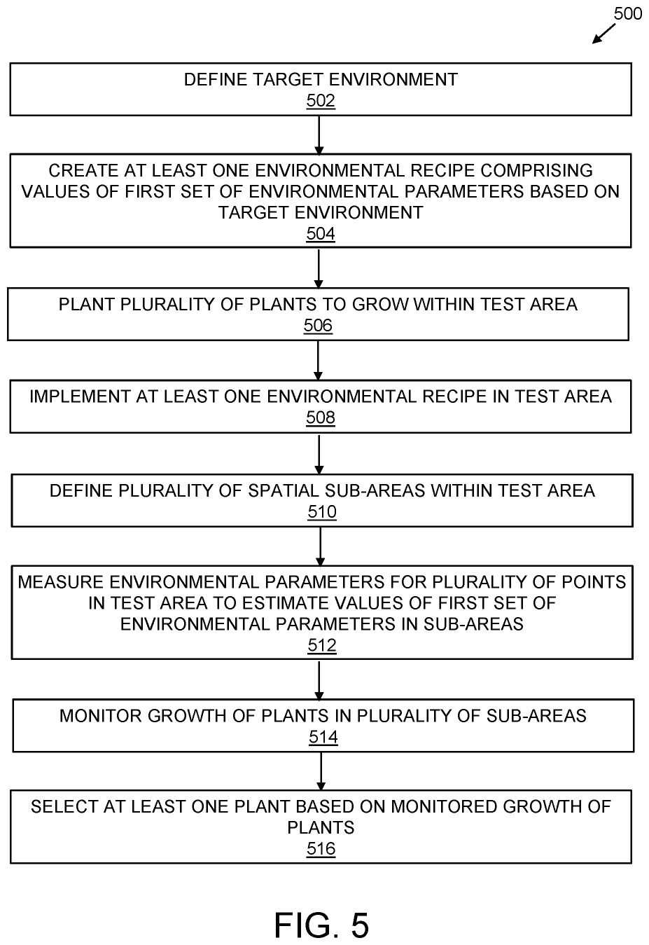

Referring to FIG. 5, illustrated are steps of a method 500 for selecting a plant variety for a target environment, in accordance with an embodiment of the present disclosure. At step 502, a target environment is defined. At step 504, at least one environmental recipe is created, comprising values of a first set of environmental parameters based on target environment. At 506, a plurality of plants are planted to grow within the test area, and in step 508, at least one environmental recipe is implemented in the test area. At step 510, a plurality of spatial sub-areas are defined within the test area and in step 512, environmental parameters are measured for a plurality of points in the test area, to estimate values of first set of environmental parameters in sub-areas. At step 514, growth of the plants in a plurality of the sub-areas is monitored. At step 516, at least one plant is selected based on the monitored growth of the plants.

The steps 502 to 516 are only illustrative and other alternatives can also be provided where one or more steps are added, one or more steps are removed, or one or more steps are provided in a different sequence without departing from the scope of the claims herein.

The steps 502 to 512 are only illustrative and other alternatives can also be provided where one or more steps are added, one or more steps are removed, or one or more steps are provided in a different sequence without departing from the scope of the claims herein.

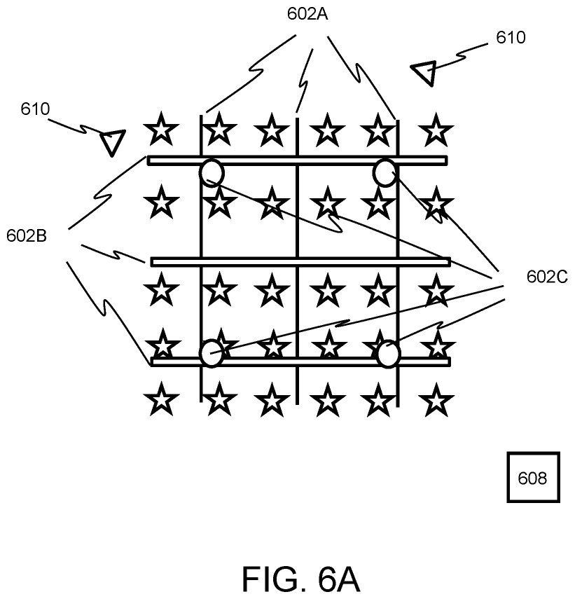

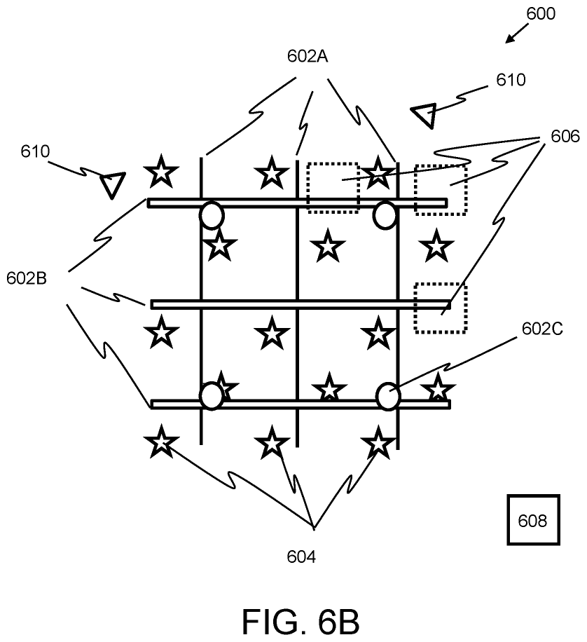

Referring to FIG. 6A and 6B illustrated is an exemplary representation of system 100 that generates heterogeneous environmental conditions within a test area according to FIG. 2 in accordance with an embodiment of the present disclosure. Environmental manipulators controlling precipitation (marked with solid lines) 602A, light intensity (such as lamps) 602B and temperature (circles in the FIG. 602C, are adjusted within the test area 600 to generate conditions corresponding to those presented in FIG. 2. A first sensory arrangement comprises sensors that measure the values of the first set of environmental parameters for a plurality of points (stars in the FIGS. 604 in the test area to estimate the values of the first set of environmental parameters in the sub-areas (example areas indicated with dashed lines in FIG. 6B) 606. A second sensory arrangement 610 in the figure is a camera. The camera is connected to controller arrangement 608 or to server system. Importantly, the first sensory arrangement does not need to measure the values of the third set of environmental parameters at the sub-areas as the values can be interpolated by using computational methods and optionally other data. The controller arrangement 608 is connected to the environmental manipulators and the sensors and is programmed to implement one or more environmental recipes by affecting the environmental conditions through the environmental manipulators and measuring the realised conditions through the sensors in the plurality of points 604 via the sensory arrangement. The sensor data can be provided and stored to a server system. The server system can execute all or part of calculations. FIG. 6A is an illustration of a set up with a larger amount of environmental sensors 604 than in FIG. 6B.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A method for obtaining new plant growth data according to an experimentation objective, the method comprising: obtaining a trained plant growth model comprising plant growth model parameters;
defining an experimentation objective, wherein the experimentation objective comprises reducing uncertainty about a plant growth model parameters;
defining a set of experimentation alternatives;
obtaining a data set of experimentation alternative conditions;
defining an experimental design utility function based on the experimentation objective;
selecting an experimentation plan from the set of experimentation alternatives by using the trained plant growth model, the experimental design utility function, and the data set of experimentation alternative conditions; and
performing the selected experimentation plan to obtain new plant growth data.

2. The method according to claim 1, wherein the plant growth model parameters are updated based on the obtained new plant growth data.

3. The method according to claim 1, wherein defining the set of experimentation alternatives comprises performing at least one experiment in a test area according to at least one experiment-specific environmental recipe, the environmental recipe comprising values of a first set of environmental parameters, and the method further comprises:
defining a test area;
defining a plurality of spatial sub-areas within the test area, wherein within each sub-area values of the first set of environmental parameters are within a predefined range;
planting a plurality of plants to grow within the test area;
adjusting environmental conditions for the test area according to the environmental recipe;
measuring the values of the first set of environmental parameters for a plurality of points in the test area to estimate the values of the first set of environmental parameters in the sub-areas;
monitoring growth of the plants in the plurality of sub-areas to obtain new plant growth data.

4. The method according to claim 1, further comprising
defining a target environment;
obtaining target environment data; and
using the target environment data for selecting the experimentation plan.

5. The method according to claim 2, wherein the plant growth model and the target environment data are used for selecting a plant variety for the target environment.

6. The method according to claim 1, wherein the set of experimentation alternatives comprises combinations of experiments and the experimental design utility function evaluates the combinations of experiments.

7. The method according to claim 3, wherein the at least one environmental recipe is adjusted to provide heterogeneous environmental conditions in the test area to expose the plurality of plants to gradients of environmental conditions.

8. The method according to claim 3, wherein the at least one environmental recipe is based on identified environmental conditions observed in at least one historical experiments that characterize and differentiate performance of different plant varieties.

9. The method according to claim 4, wherein the method further comprises
defining a plant variety of interest;
selecting a performance score; and
defining the experimentation objective as an estimation of the performance score of the plant variety of interest in the target environment.

10. The method according to claim 1, wherein the new plant growth data comprises growth traits estimated based on changes of phenotype traits over a period of time.

11. A method for selecting a plant variety for a target environment, the method comprising:
defining the target environment;
creating at least one environmental recipe comprising values of a first set of environmental parameters based on the target environment;
planting a plurality of plants to grow within a test area;
implementing the at least one environmental recipe in the test area;
defining a plurality of spatial sub-areas within the test area, wherein within each sub-area the values of the first set of environmental parameters are within a predefined range;
measuring environmental parameters for a plurality of points in the test area to estimate the values of the first set of environmental parameters in the sub-areas;
monitoring growth of the plants in the plurality of the sub-areas and selecting at least one plant based on the monitored growth of the plants.

12. A system for creating new plant growth data comprising:
a test area for growing a plurality of plants, wherein the test area comprises a plurality of spatial sub-areas, wherein the plurality of spatial sub-areas are under conditions of a first set of environmental parameters,
environmental manipulators, the environmental manipulators configured to adjust environmental conditions within the test area according to one or more environmental recipes;
a first sensory arrangement configured to measure values of the first set of environmental parameters for a plurality of points in the test area to estimate the values of the first set of environmental parameters in the sub-areas;
a second sensory arrangement configured to monitor growth of the plants in the plurality of sub-areas, wherein the second sensory arrangement comprises at least one of a growth sensor or a camera and
a server arrangement for storing a new plant growth data, the new plant growth data comprising the measured values of the first set of environmental parameters and monitored growth.

13. system according to claim 12, wherein the environmental manipulators are arranged to adjust the environmental conditions within the test area to form gradients of the environmental conditions wherein the gradients are within range of 25% to 70%.
